(19) United States
(12) Patent Application Publication
(10) Pub. No.: US 2016/0097746 A1
(43) Pub. Date: Apr. 7, 2016

(54) METHOD FOR EVALUATING ACOUSTIC SENSOR DATA IN A FLUID CARRYING NETWORK AND EVALUATION UNIT

(71) Applicant: GUTERMANN AG, Baar (CH)

(72) Inventor: Andreas TRAUB, Stuttgart (DE)

(73) Assignee: GUTERMANN AG, Baar (CH)

(21) Appl. No.: 14/785,449

(22) PCT Filed: Apr. 19, 2013
(86) PCT No.: PCT/EP2013/058213

§ 371 Date: Oct. 19, 2015

(51) Int. Cl. G01N 29/44

(52) U.S. Cl. CPC G01N 29/44; G01N 29/4463; G01N 2291/023; G01N 2291/015

(57) ABSTRACT

A method for evaluating sensor data in a fluid carrying network and a corresponding evaluation unit. The method comprising providing a numerical network model, which at least partly represents an acoustic property of the fluid carrying network; receiving sensor data of at least one acoustic sensor placed on the fluid carrying network; calculating model data by using the numerical network model; and evaluating the received sensor data by considering the model data.

### TECHNICAL FIELD OF THE INVENTION

The present invention is related to a method for evaluating acoustic sensor data in a fluid carrying network and a corresponding evaluation unit.

### BACKGROUND OF THE INVENTION

Leak detection in a water distribution network is known from the prior art. Thereby, acoustic sensors are placed on the pipelines of the network for determining acoustic signals, which then are evaluated by using a central evaluation unit. For example, U.S. Pat. No. 6,567,006 B1 discloses a method for leak detection, which determines characteristic parameters of the measured acoustic signals by performing a wavelet transformation and which compares the determined parameters to predetermined parameters stored in a dictionary. Thereby, the predetermined parameters are obtained from previously evaluated acoustic measurements.

### SUMMARY OF THE INVENTION

The present invention has the objective to propose an improved method for evaluating acoustic sensor data in a fluid carrying network and an improved evaluation unit.

This objective is achieved by a method comprising the features specified in claim 1. An evaluation unit as well as further embodiments of the invention are specified in the further claims.

The present invention involves a method for evaluating acoustic sensor data in a fluid carrying network, wherein the method comprises the steps of:
providing a numerical network model, which at least partly represents an acoustic property of the fluid carrying network;
receiving sensor data of at least one acoustic sensor placed on the fluid carrying network;
calculating model data by using the numerical network model; and
evaluating the received sensor data by considering the model data.

This way efficient and reliable leak detection is achieved, including a precise localization of the detected leak within the fluid carrying network. The sensor data may be received once or multiple times.

In one example, the fluid carrying network is a network of pipelines for a fluid such as natural gas or drinking water. Further, the network may comprise nodes, which are interconnected by connection lines or pipelines. Further, the acoustic sensor is configured to determine at least one acoustic property of the fluid, in particular the power and/or frequency of a sound or a vibration. Throughout the description, the term “sensor” is used in the meaning of the mentioned “acoustic sensor” and the term “sensor data” refers to data received from such an acoustic sensor.

The numerical network model comprises data which represents the pipeline network and the fluid. In one example, the numerical network model is established, at least approximately, by using a geographic information system (GIS). The model data is determined by using the numerical network model, which is implemented by the execution of a program on a data processing unit such as a computer, in particular a microprocessor. The term “considering” is understood in a broad sense of data evaluation, in particular the term includes a combination, a systematic data fusion, a correlation, a functional dependency, a comparison between the model data and the sensor data or a verification of the model data with the sensor data, or vice versa.

Surprisingly, the invention is particularly advantageous for providing a comprehensive diagnostic method for the fluid carrying network, because the numerical network model can be used to detect abnormal states or behavior of the network. In addition, the numerical network model provides an overall view of the fluid carrying network, eliminates ambiguities, allows for verification of the sensor data and provides for an improved service and maintenance planning.

The numerical network model is a special type of physical model, which represents the physical behavior of acoustic signals and/or which is based on acoustic modeling. In this case, the numerical network model represents at least partly and/or at least one acoustic property of the fluid carrying network, in particular the propagation of acoustic signals in the fluid carrying network.

A physical model is fundamentally different from a phenomenological model, which for example describes or represents actual or previously observed measurements, because a physical model is based on physical laws and relations, which define underlying dependencies, e.g. the exponential characteristics of sound attenuation. Thus, as an example, a physical model can be used without measurements, particularly for implementing a specific function such as the characteristics of a transfer function.

A physical model is advantageous for evaluating sensor data of a fluid carrying network, because it reduces the complex interactions in a network to efficiently manageable physical relations. This is particularly advantageous for large installations with hundreds or thousands of sensors.

In an embodiment of the invention, the model data is determined by using data representing an acoustic discontinuity in the fluid carrying network, in particular at least one of:
a node,
a bend,
a change of material,
a change of a wall thickness, and
a change of a diameter.

In a further embodiment of the invention, the model data is determined by using data representing at least a part of the structure of the fluid carrying network, in particular a main structure and/or a major part thereof. This allows determining a comprehensive status of the fluid carrying network. The structure of the fluid carrying network refers to all kind of geometrical dimensions of the network elements such as pipes, junctions or valves and further to the physical properties of these elements such as functional or material properties.

In a further embodiment of the invention, the model data is determined by using data representing a pipeline or a pipeline section of the fluid carrying network, in particular a parameter related to an acoustical property thereof, further in particular at least one of:
a length,
a diameter,
a cross-sectional area, and
a wall thickness.

The term “pipeline” or “pipe” as used throughout the description and the claims includes all kind of fluid carrying vessels such as a straight, a bended or curved pipe, an elongated or short pipeline as well as a part of a pipeline such as a pipeline section.

In a further embodiment of the invention, the model data is determined by using data representing a network node of the fluid carrying network, in particular at least one of:
a junction,
a hydrant, and
a valve.

In a further embodiment of the invention, the numerical network model and/or the model data is determined by using the received sensor data. This way a dynamically changing evaluation and/or model adaptations can be achieved.

In a further embodiment of the invention, the model data is determined by using at least one transfer function representing an acoustic signal propagating through the fluid carrying network, in particular a sound signal in a pipeline, wherein the transfer function in particular comprises at least one of:
an attenuation,
a phase shift, and
a signal propagation time.

This way a modeling of complex dependencies is achieved.

In one example, the damping and/or the phase shift depend on a signal frequency and/or a length of a connecting line in particular the length of the pipeline.

In a further embodiment of the invention, the model data is determined by calculating an energy loss between different locations of the fluid carrying network, in particular at least one of:
a loss along a pipeline, and
a loss caused by a discontinuity.

In a further embodiment of the invention, the method comprises the additional step of using an adaptive algorithm for adjusting the numerical network model, in particular for adjusting its network structure and/or its physical properties, further in particular by adjusting the numerical network model according to verified information and/or the received sensor data.

With this adaptive algorithm, also called learning process or learning algorithm, an ongoing improvement of the network model can be achieved. Further, due to verified acoustic measurements, the network model can be checked for plausibility and improved accordingly. This is particular advantageous in a case, where approximations and/or assumptions have been used as starting values. In one example, the adaptive algorithm is carried out frequently, in particular daily.

In a further embodiment of the invention, the method comprises the additional step of verifying the model data, in particular by a semantic interpretation or by using a nearest-neighbor-algorithm, and of adjusting the numerical network model accordingly. This improves the accuracy and robustness of the results and/or the network model. In addition, the model data may be mutually checked for plausibility to avoid “False Positives”.

In one example, a leakage on the fluid carrying network emits similar acoustic signals in both directions of the pipeline. If the connections from the leakage to the sensors on both sides are acoustically sufficiently similar, e.g. of the same material, but differ in length, the attenuation of the acoustic signals in the model can be corrected by evaluating the different intensities of the received sensor signals.

In a further example, if—according to the model—two sensors are not or only very indirectly acoustically connected, but the signal levels of these sensors measured on different days are significantly correlated or there are direct acoustic correlations between them, this should be interpreted in the way that the plausibility of the network model needs an improvement or this is an indication that the network model is implausible.

In a further example, the verification is improved by considering at least one further criterion, in particular by applying a semantic interpretation. This improves the accuracy and robustness of the results and or the network model. For example, a semantic interpretation is used for improving the accuracy of GIS data, for example by using the information that a sensor can only be arranged on an access point of the fluid carrying network, in particular a network node such as a hydrant or a valve.

In a further example, the verification is improved by using a nearest-neighbor-algorithm for finding the network nodes on which sensors are placed if their position is not known accurately. This also improves the accuracy and robustness of the results and/or the network model.

The nearest-neighbor-algorithm may also comprise the additional constraint that sensors are placed to show approximately equal acoustic attenuation between them. For example, if two connection lines are arranged so close together that they cannot be distinguished by GPS, and if there are two sensors installed close to each other, they are probably not on the same connection line.

In a further embodiment of the invention, the evaluation of the received sensor data comprises the additional step of displaying the results of the evaluation on a geographical map, in particular on a map showing the fluid carrying network. This provides for an efficient and convenient localization of the detected leaks.

In a further embodiment of the invention, the evaluation of the received sensor data comprises the additional step of using the results of the evaluation for estimating the size of a leak and/or for an automatic sensor installation planning or optimization. This way, a cost-efficient installation and effective management of maintenance and repair can be achieved.

In one example, the planning and/or optimization involves hundreds or thousands of sensors—as typically encountered in a city. With the network model according to the invention, a particular cost-efficient installation can be achieved in respect to the number of sensors needed and their optimum position.

In another example, an algorithm is used for calculating an acoustic attenuation of at least some network connections, in particular by using material data and/or data of the diameter of the pipelines. Then, the distances for placing the sensors are chosen so that the total loss between the two sensors, including junctions and reflections, does not exceed a predetermined level.

In a further example, environmental information is additionally used. This avoids non-economical placing of sensors, i.e. adjacent to a permanent source of noise.

The size of a leak can be determined by reverse calculating the noise level of a leak by using the received sensor data and/or the results of the evaluation step. This way an estimation of the leak size, i.e. the water loss per time period, can be achieved. This is valuable information, which allows for an improved estimation of the economic and environmental damage as well as of the security risk such as floods.

A leak noise is caused by a pressure difference of the fluid at the leak. The more water escapes the louder the leak (as long as the pressure drop through the leak does not decrease too much, i.e. in case of a burst of the fluid carrying network).

The estimation of the size of a leakage may be accomplished by determining the noise level at the sound source, which may also depend on material properties of the connecting line or network node such as material or wall thickness. With the help of the network model, the noise level at the source can be calculated from the measured noise level, and hence the size of the leak can be calculated.

In a further embodiment of the invention, the collection or reception of the sensor data is accomplished by receiving multiple sets of data from a plurality of acoustic sensors and the step of evaluating the received sensor data comprises combining the multiple sets of data. This way, a common leakage problem can be detected and/or localized in a particular efficient way.

In a further embodiment of the above embodiment, the combination is accomplished by correlating the multiple sets of data.

A leak event is often detected from sensor data of various sensors and/or various sequential measurements (e.g. on different days). Thus, leak detection is accomplished by comparing noise levels and/or by correlating the received multiple sets of data. The resulting data must be aggregated to lead the user to the location of the leakage. In one example, the step of evaluating provides a summary of the individual measurements or leakage events.

In a further embodiment of the above embodiment, the correlation is performed only when a noise level measurement indicates that the level of disturbing ambient noise is below a predetermined threshold level.

In a further embodiment of the two above embodiments, the evaluation of the received sensor data comprises combining a noise level measurement with the correlation of the multiple sets of data.

In one example, an acoustic correlation measurement is performed once per night. In a further example, noise level measurements are performed over a longer time period, for example 2 hours, and/or at regular intervals, for example every 10 seconds. Because the presence of a leak will generally cause a constant noise, this avoids misinterpretations of minimum noise levels caused by a temporary disturbing noise.

In a further example, the sensor measurements of different sensors are related in time to each other. Thus, if the sensor data of these multiple sensors simultaneously, i.e. on the same day, shows a certain pattern, they are likely to be cause by the same sound source. Likewise, a spatial relation may be considered, i.e. only if the attenuation between the sensors is sufficiently small can the observed pattern of the sensor data be caused by the same sound source.

The sending of the sensor data can either be periodic or it can be triggered from outside the sensor or from an algorithm inside the sensor. The latter is particularly advantageous for a timely detection of abnormal acoustic events in the fluid pipe network such as a sudden leakage which may require immediate action.

In another example, the spectrum of the received sound data is compared to the spectra of a sound source as calculated by the acoustic network model. A sufficient similarity between these spectra may indicate a common cause.

The combination of the above examples results in a very robust classification. This can be further improved by a learning algorithm (e.g. neural network), which is trained for example by confirming or rejecting detected leakage events by the user after having checked the pipelines or nodes on site. In the case of confirmation, the actually measured amount of leakage may be used to improve the algorithm for estimating the leak size.

In another example, the combination, in particular the correlation of the sensor data, allows to resolve ambiguities in respect to the position of the leakage.

Leak sounds are generated locally and the sound wave packets propagate from the origin along to two opposite directions and arrive at different times at the receiving sensors. The localization is uniquely determined within a single section, because from a time shift one can calculate back to the source position. If one places the sensors at any two points of the fluid carrying network in a mesh configuration, the calculation is problematic, because the sound paths can be ambiguous, as there are several possible positions for the sound source. However, with the method according to the invention, these ambiguities can be resolved efficiently.

In another example, a correlation is determined between several pairs of sensors by using the network model, which relates them to each other. Thereby, a sound source is chosen in the network model at a position, where most of the sensor couples show a peak in their correlation. Further, the various correlations are weighted by the probability with which they could measure a correlation to the location in question. Again, this may be calculated from the above mentioned attenuation.

A sound source in the fluid carrying network frequently not only generates a correlation between two adjacent sensors, but also between further sensors. If the sound source is located between the correlating sensors, then one speaks of an “in-bracket correlation”.

In another example, more than one “in-bracket correlation” is available and these correlations are brought in line with the aid of the network model according to the invention so as to calculate the actual speed of sound. From the actual speed of sound the remaining average wall thickness can be calculated, which in turn is a measure of the remaining life of the pipeline.

If sound source is outside of the pair of correlating sensors, then one speaks of an “out-of-bracket correlation”. With an out-of-bracket correlation and by using the network model according to the invention, one can calculate the speed of sound between the sensors independent of other correlations.

In another example, correlation measurements are recorded regularly over the years. The measured sound velocities can be averaged with a sliding average relatively accurately. Thereby the averaging time is in a range, during which in the wall thickness changes measurably, that is about 2 to 3 years.

In a further example, the correlations are weighted according to their signal to noise ratio. This is useful, because the accuracy of the measured speed of sound depends on the quality of the correlation.

In a further example, the relationship between the average remaining wall thickness and the likelihood of leaks can be initially estimated by consulting general literature. However, local factors such as soil texture, topology of the landscape, climate and type of pipe can have a considerable impact on the precision of the estimation. In the sense of “data mining” an adaptive algorithm can be used to capture this relationship more accurately. Thereby the detected and user-confirmed leakage events are set in relation to the wall thickness.

The knowledge of the condition of the fluid carrying network, in particular the corrosion or the remaining wall thickness, is required for planning for the yearly investments in a water treatment plant as well as for achieving an effective maintenance and repair. This is also called rehabilitation planning and/or pipe condition assessment.

Further, the invention involves an evaluation unit for a fluid carrying network, wherein the evaluation unit is configured to perform the method according to any one of the previous embodiments or examples.

In a further embodiment of the invention, the method comprises the additional step of triggering a sending of sensor data in the at least one acoustic sensor, wherein the triggering is performed upon detecting an abnormal acoustic event and/or if the measured noise level exceeds a predetermined threshold level.

Further, the invention involves an evaluation unit for a fluid carrying network, wherein the evaluation unit comprises a data interface for receiving sensor data and a data processing unit for providing output data to an output unit, wherein the output data is dependent on the received sensor data. Thereby the evaluation unit is configured to use a numerical network model for providing model data and to determine the output data with an additional dependency on this model data.

It is explicitly pointed out that any combination of the above-mentioned embodiments, or combinations of combinations, is subject to a further combination. Only those combinations are excluded that would result in a contradiction.

### BRIEF DESCRIPTION OF THE DRAWINGS

Below, the present invention is described in more detail by means of exemplary embodiments and the included drawing. It is shown in:

FIG. 1 a simplified block diagram illustrating an embodiment of the method according to the invention comprising an acoustic model 40,

FIG. 2 an illustration of a further embodiment of the acoustic model according to FIG. 1, comprising a junction node n with edges j, k and l, and

FIG. 3 an illustration of a further embodiment of the acoustic model according to FIG. 1, comprising nodes i, j and k.

### BRIEF DESCRIPTION OF THE INVENTION

The described embodiments are meant as illustration examples and shall not confine the invention. Throughout the following description, the terms “pipeline”, “pipe”, “pipeline section”, and “pipe section” and “edge” are used synonymously.

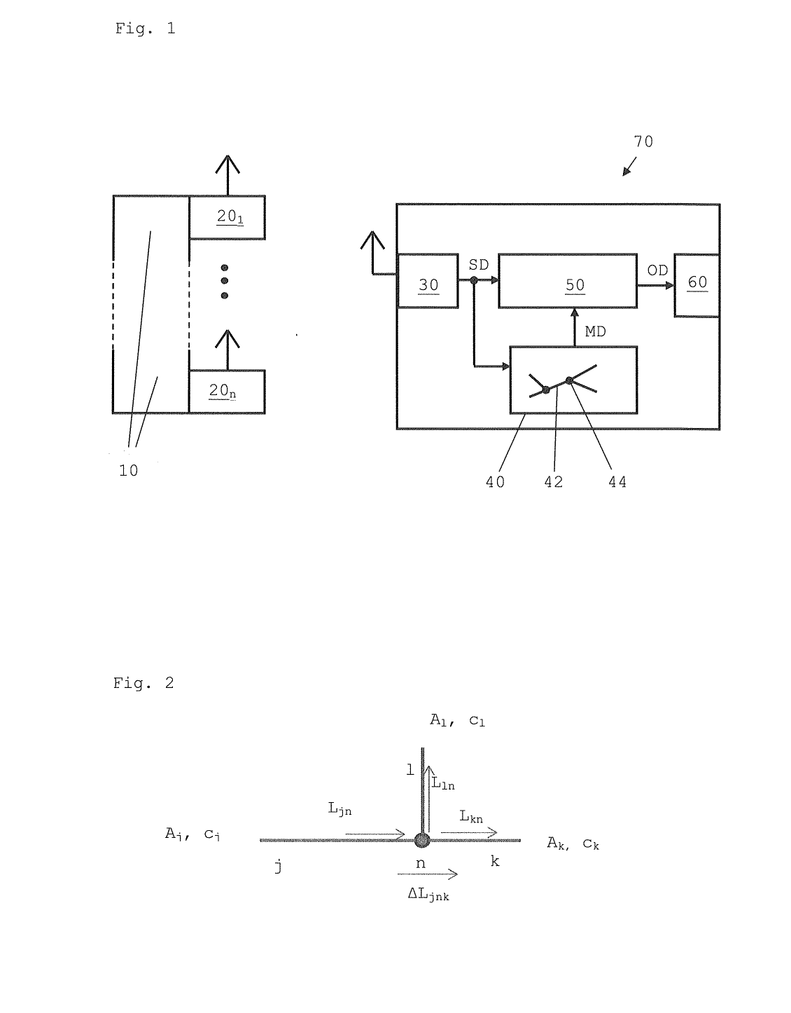

FIG. 1 shows a simplified block diagram illustrating an embodiment of the method according to the invention, which is used for evaluating sensor data.

The block diagram schematically shows a water distribution network 10 as a fluid carrying network, a number of n sensors 20ᵢ to 20ₙ and an evaluation unit 70. The number n of the sensors is a relative large number, in typical examples more than 1000 or even more than 10′000. The water distribution network 10 and the large number of sensors are schematically indicated by the dotted lines, the three intermediate dots and the two outmost sensors 20ᵢ to 20ₙ.

Each of the sensors 20ᵢ to 20ₙ is attached to the water distribution network 10 for measuring sound signal of the water distribution network 10. Further, each of sensors the 20ᵢ to 20ₙ is connected to the evaluation unit 70 via a wireless connection for transmitting data. The wireless connections are indicated by corresponding antenna symbols.

The evaluation unit 70 comprises a data interface 30, a numerical network model implemented as an acoustic model 40, a data processing unit 50 and a display 60 as output unit, which displays a representation of the water distribution network 10 on its screen.

The data interface 30 is connected to the antenna or is the antenna itself. On the other hand, the data interface 30 is connected to the data processing unit 50 and to the acoustic model 40 for transmitting the data from the sensors as sensor data SD to both, the data processing unit 50 and the acoustic model 40. Further, the acoustic model 40 is operationally connected to the data processing unit 50 for transmitting model data MD from the acoustic model 40 to the data processing unit 50 and the data processing unit 50 is connected to the display 60 for transmitting output data OD from the data processing unit 50 to the display 60. The operational connection between the acoustic model 40 and the data processing unit 50 may be implemented by any kind of data transfer, in particular by a data transfer between different software modules, for example using a common storage space.

The acoustic model 40 comprises edges 42 representing pipeline sections and nodes 44 representing junctions or other acoustic discontinuities. In this largely simplified example for illustration purposes, the model represents a network of five edges 42 connected to each other via two nodes 44.

The data processing unit 50 is configured to compare the sensor data SD to the model data MD received from the acoustic model 40. This is accomplished by executing a further algorithm, which—in addition to a first algorithm for processing the received the sensor data SD—relates the previously processed sensor data SD to the model data MD, for example by performing a direct comparison.

In evaluating the sensor data SD, the method according to this embodiment of the invention performs the following steps:
receiving data from the acoustic sensors 20₁ to 20ₙ via the wireless connection;
transmitting the received data as sensor data SD to the data processing unit 50 and to the acoustic model 40;
calculating the model data MD by using the acoustic model 40. This is accomplished by calculating the propagation of a sound signal in the network according to data, which represents edges 42, nodes 44, and the corresponding transfer functions; and
using the data processing unit 50 in order to evaluate the received sensor data SD and the model data MD.

In this example the sensor data SD is compared to the model data MD and if the difference between the sensor data SD and the model data MD exceeds a predetermined level, a so called threshold, the evaluation unit indicates on the display unit 60 that a leakage is likely to be present at a location of the water distribution network 10, which is indicated according to the model data.

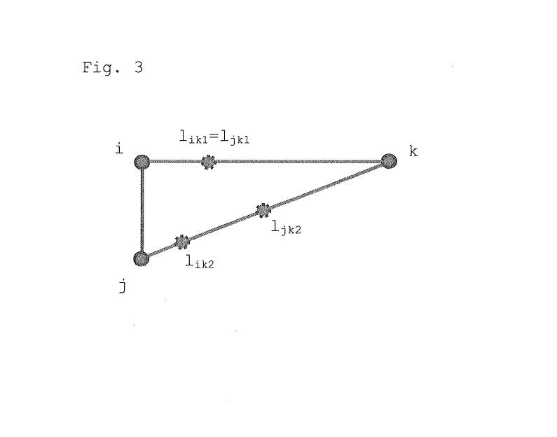

FIG. 2 shows an illustration of a further embodiment of the acoustic model according to FIG. 1. The acoustic model comprises edges j, k and l and a node n, which is a junction. Edges j, k and l represent pipe sections of the fluid carrying network. The nodes generally represent acoustic discontinuities like changes in pipeline material or diameter, junctions, valves or hydrants.

In this example, the pipe sections j, k and l are assumed to be symmetric around their axis and to have uniform and linear acoustic properties along their length. The acoustic signal (pressure variation) is then attenuated exponentially along an edge with an attenuation constant β:

p(x)=p(x₀)e^{-βx} (F1)

wherein p(x) is the sound power of the acoustic signal at a certain location x and p(x₀) is an initial sound power of the acoustic signal at an initial location x₀ of the edge.

The corresponding noise level L(x) is the logarithm of the relative sound power and decreases linearly along the edge:

$$L ( x ) = L ( {x}_{0} ) - 10 {log}_{10} \frac{{p ( x )}^{2}}{{p ( {x}_{0} )}^{2}} = L ( {x}_{0} ) - 20 {log}_{10} \frac{p ( x )}{p ( {x}_{0} )} = L ( {x}_{0} ) - 8.686 β \cdot x \qquad ( F2 )$$

wherein L(x₀) denotes the noise level at an initial location x₀.

The attenuation ΔLᵥ of an edge e of a length l is:

ΔLₑ=8.686β·l (F3)

wherein the edge e represents one of the edges j, k, l.

Similarly, the attenuation across the nodes can be estimated. For example, each house connection along a water mains distribution pipe causes an acoustic attenuation. For such a junction like in FIG. 2, where the edges j and k could represent a mains distribution pipe, and edge l a house connection, the attenuation ΔLⱼₙₖ from edge j to edge k across node n can be estimated as:

$$Δ {L}_{jnk} = {L}_{kn} - {L}_{jn} = 20 \; 1 g \frac{2 \frac{{A}_{k}}{{c}_{k}}}{2 \frac{{A}_{k}}{{c}_{k}} + \frac{{A}_{l}}{{c}_{l}}} , \qquad ( F4 )$$

where Lₖₙ denotes the sound level at the end of edge k facing node n, Lⱼₙ denotes the sound level at the end of edge j facing node n, Aₖ denotes the cross-sectional area of edge k, and cₖ its sound velocity. Similarly, Aₗ denotes the cross-sectional area of edge l, and cₗ its sound velocity. In this case, it is assumed that Aₖ=Aⱼ and cₖ=cⱼ.

The attenuation ΔLₚₐₜₕ along a single path in the network model then is the sum of the attenuations of all edges and nodes along the path:

$$Δ {L}_{path} = {\sum }_{e} Δ {L}_{e} + {\sum }_{n} Δ {L}_{jnk} \qquad ( F5 )$$

where e is the index of the edges on the path and n is the index of the nodes, and ΔLᵥ and ΔLⱼₙₖ are determined using expressions (F3) and (F4) respectively.

In a meshed network with multiple propagation paths between to nodes, the combined attenuation will generally be determined by the path with the smallest attenuation because of the exponential nature of the attenuation. Therefore, (F5) can also be used in meshed networks by using the path with the smallest attenuation.

(F5) has a number of very useful applications, in particular for leak detection in the fluid carrying network, since the noise level of a leak generally increases with the leak size. In one embodiment of the invention, therefore, (F5) can be used to estimate the leak size if the position of the leak is known (e.g. from correlation of the acoustic signals of two sensors).

In another embodiment of the invention, (F5) can be used to determine the optimal density of noise sensors in the pipe network as a balance between the requirements
(a) the sensors should be close enough to reliably detect leaks of a given size corresponding to a given source sound intensity
(b) for economic reasons, the sensors should be as sparse as possible

In another embodiment of the invention, (F5) can be used to determine if a noise level increase detected by two sensors can be caused by the same leak.

In another embodiment of the invention, the spatial information which can be derived from the edges and nodes of the acoustic model can be combined with the temporal information which can be derived from sequential measurements or measurement parts at different times. For example, to determine if a noise level increase detected by two sensors is caused by the same leak it would also be useful to require a temporal correlation between those noise levels.

In order to increase the sensitivity for detecting leaks, it is useful to average sequential correlation measurements e.g. recorded on different days. However, if some correlation measurements are disturbed by another very loud noise source, e.g. an ambient noise, they would significantly reduce the sensitivity of the averaged result. Therefore, in another embodiment of the invention, it is useful to combine the temporal information contained in the acoustic model in such a way that the noise level measurements Lᵢ(tₙ) and Lₖ(tₙ) of two sensors i and k at time tₙ are used to calculate a weight factor wᵢₖ(tₙ) for averaging correlation measurements Rᵢₖ(tₙ) between those sensors:

$$\overline{{R}_{ik}} = {\sum }_{n} {w}_{ik} ( {t}_{n} ) {R}_{ik} ( {t}_{n} ) \qquad ( F6 )$$

If the pressure in a fluid carrying network is constant, then a leak will generally cause a noise which is constant or increasing if the leak size increases. Therefore, disturbing noises can be detected for example with a median filter from the sequential noise level measurements of a sensor. In the simplest case, the weight function for each sensor wᵢ(tₙ) then is a unit step function u with a disturbing noise level threshold Lₜₕᵣ:

wᵢ(tₙ)=u(Lₜₕᵣ−(Lᵢ(tₙ)−median(Lᵢ(tₙ₋₁),Lᵢ(tₙ),Lᵢ(tₙ₊₁))) (F7)

and the combined weight function the minimum of both sensors:

wᵢₖ(tₙ)=min(wᵢ(tₙ),wₖ(tₙ)) (F8)

In another embodiment of the invention, the acoustic model contains the sound propagation time tₑ along any edge e. If the edge represents an axis symmetric pipe section, tₑ can be determined from the pipe parameters:

$${t}_{e} = \frac{{l}_{e}}{{c}_{e}} = \frac{{l}_{e} \sqrt{1 + \frac{K}{E} \frac{{D}_{i}}{s}}}{{c}_{w}} \qquad ( F7 )$$

where lₑ is the length of the axis, cₑ its sound velocity, E its elasticity modulus, Dᵢ its internal diameter, and s its wall thickness. K is the bulk modulus of the fluid in the pipe, and c_{w} its sound velocity. tₑ can also be measured with two acoustic sensors e.g. using a correlation of their signals.

In many cases, timely information on abnormal events in pipeline networks such as leaks is important, in particular to reduce the damage caused by the event. In a further embodiment of the invention, the acoustic sensors (20) can detect such events by comparing the acoustic measurements with some local model data (MD) representing the normal acoustic conditions at the sensor location. Upon detection of an abnormal event, the sensors can then actively initiate a communication with the evaluation unit (70) to inform about the abnormal event. The model data (MD) representing the normal acoustic conditions at the sensor location can either be determined from previous measurements of the sensor, from parameters representing the acoustic properties of the pipe network and/or the environment at the sensor location, or from a combination thereof. For example, similar to (F7), an abnormal increase in the noise level L(tₙ) of a sensor can be determined by comparing it to the median of the previous k measurements:

L(tₙ)−median(L(tₙ₋₁),L(tₙ₋₂), . . . , L(tₙ₋ₖ)>Lₜₕᵣ, (F8)

where Lₜₕᵣ is a threshold for an abnormal noise level increase and may, for example, depend on the ambient noise levels at the sensor location.

FIG. 3 shows an illustration of a further embodiment of the acoustic model according to FIG. 1, comprising nodes i, j and k and possible noise source positions lₜₕ₁, lⱼₖ₂ and further positions lⱼₖ₁, lᵢₖ₂.

This Figure shows a very useful application of an acoustic model with sound propagation times for the resolution of ambiguities in correlation measurements. The noise source causing a correlation between two sensors at nodes i and k could be located either at position lᵢₖ₁ or at lᵢₖ₂. However, using the correlation between another pair of sensors, e.g. sensors at nodes j and k, this ambiguity can be resolved.

1. A method for operating a fluid carrying network, comprising the steps of:
providing a numerical network model, which at least partly represents an acoustic property of the fluid carrying network;
receiving sensor data of at least one acoustic sensor placed on the fluid carrying network;
calculating model data by using the numerical network model, the model data being determined by using data representing an acoustic discontinuity in the fluid carrying network, in particular at least one of: a node, a bend, a change of material, a change of a wall thickness, and a change of a diameter; and
evaluating the received sensor data by considering the model data.

2. (canceled)

3. The method according to claim 1, wherein the model data is determined by using data representing at least a part of the structure of the fluid carrying network, in particular a main structure or a major part thereof.

4. The method according to claim 1, wherein the model data is determined by using data representing a pipeline section of the fluid carrying network, in particular a parameter related to an acoustical property thereof, further in particular at least one of:
a length,
a diameter,
a cross-sectional area, and
a wall thickness.

5. The method according claim 1, wherein the model data is determined by using data representing a network node of the fluid carrying network, in particular at least one of:
a junction,
a hydrant, and
a valve.

6. The method according to claim 1, wherein at least one of the numerical network model and the model data is determined by using the received sensor data.

7. The method according to claim 1, wherein the model data is determined by using at least one transfer function representing an acoustic signal propagating through the fluid carrying network, wherein the transfer function in particular comprises at least one of:
an attenuation,
a phase shift, and
a signal propagation time.

8. The method according to claim 1, wherein the model data is determined by calculating an energy loss between different locations of the fluid carrying network, in particular at least one of:
a loss along a pipeline, in particular along its wall, and
a loss caused by a discontinuity.

9. The method according to claim 1, further comprising:
using an adaptive algorithm for adjusting the numerical network model, in particular for adjusting at least one of a network structure and physical properties, further in particular by adjusting the numerical network model according to at least one of verified information and the received sensor data.

10. The method according claim 1, further comprising:
verifying the model data, in particular by a semantic interpretation or by using a nearest-neighbor-algorithm, and of adjusting the numerical network model accordingly.

11. The method according to claim 1, wherein the evaluation of the received sensor data comprises the additional step of displaying the results of the evaluation on a geographical map, in particular on a map showing the fluid carrying network.

12. The method according to claim 1, wherein the evaluation of the received sensor data comprises the additional step of using the results of the evaluation for estimating the size of a leakage and/or for an automatic sensor installation planning or optimization.

13. The method according to claim 1, wherein the collection or reception of the sensor data is accomplished by receiving multiple sets of data from a plurality of acoustic sensors and the step of evaluating the received sensor data comprises combining the multiple sets of data.

14. The method according claim 13, wherein the combination is accomplished by correlating the multiple sets of data.

15. The method according claim 14, wherein the correlation is performed only when a noise level measurement indicates that a level of disturbing ambient noise is below a predetermined threshold level.

16. The method according to claim 14, wherein the evaluating of the received sensor data comprises combining a noise level measurement with the correlation of the multiple sets of data.

17. The method according to claim 1, further comprising:
triggering a sending of sensor data in the at least one acoustic sensor the triggering being performed upon detecting an abnormal acoustic event and/or if the measured noise level exceeds a predetermined threshold level.

18. An evaluation unit for a fluid carrying network, the evaluation unit being configured to perform the method according to claim 1.

19. An evaluation unit for a fluid carrying network, comprising:
a data interface for receiving sensor data; and
a data processing unit for providing output data to an output unit, the output data being dependent on the received sensor data,
wherein the evaluation unit is configured to use a numerical network model for providing model data and to determine the output data with an additional dependency on this model data.
